(19) United States
(12) Patent Application Publication
(10) Pub. No.: US 2014/0167554 A1
(43) Pub. Date: Jun. 19, 2014

(54) Squirrel Cage Rotor and Rotary Electric Machine

(71) Applicants: Manabu Oshida, Hitachinaka-shi (JP); Yukiaki Shimizu, Hitachinaka-shi (JP); Hiroshi Hamano, Hitachinaka-shi (JP); Keiji Oda, Hitachinaka-shi (JP)

(72) Inventors: Manabu Oshida, Hitachinaka-shi (JP); Yukiaki Shimizu, Hitachinaka-shi (JP); Hiroshi Hamano, Hitachinaka-shi (JP); Keiji Oda, Hitachinaka-shi (JP)

(73) Assignee: Hitachi Automotive Systems, Ltd., Hitachinaka-shi (JP)

(21) Appl. No.: 14/237,126

(22) PCT Filed: Aug. 8, 2012
(86) PCT No.: PCT/JP2012/070245

§ 371 Date: Feb. 4, 2014

(30) Foreign Application Priority Data
Aug. 30, 2011 (JP) 2011-187098

(51) Int. Cl. H02K 17/16; H02K 3/02

(52) U.S. Cl. CPC H02K 17/165; H02K 3/02
USPC 310/211

(57) ABSTRACT

A squirrel cage rotor includes: a rotor core having a plurality of slots formed in a circumferential direction, each slot extending in an axial direction; a plurality of conductive bars housed within the respective slots of the rotor core and having both ends thereof projecting out from end faces in an axial direction of the rotor core; and a pair of end rings disposed at both ends of the rotor core, each end ring having a plurality of fitting portions into which respective end portions of the conductive bar projecting out from the end faces of the rotor core in the axial direction are fitted. A material of the conductive bar is an aluminum alloy having an aluminum component ratio of 99.00% or more, and a material of the end ring is an aluminum alloy having proof stress higher than that of the material of the conductive bar.

### TECHNICAL FIELD

The present invention relates to a squirrel cage rotor and a rotary electric machine using the squirrel cage rotor.

### BACKGROUND ART

Conventionally, there has been known a rotary electric machine using an assembly type squirrel cage rotor in which many conductive bars and an end ring are assembled by welding, brazing, or the like to a rotor core (see PTL 1).

### CITATION LIST

### Patent Literature

PTL 1: JP 2008-161024 A

### SUMMARY OF INVENTION

### Technical Problem

In a squirrel cage rotor used in a rotary electric machine described in the above PTL 1, from viewpoints of weight-saving and improved motor efficiency (ratio of output mechanical energy to input electrical energy), a material of each of a conductive bar and an end ring may be pure aluminum. The pure aluminum means an aluminum alloy having an aluminum component ratio of 99.00% or more.

When the squirrel cage rotor is rotated at a high-speed (for example, a circumferential speed of 250 m/s. The circumferential speed is an amount defined by: (outside diameter/2)×angular velocity.), a large rotational centrifugal force is applied to the end ring. In a case where the pure aluminum is used as a material of each of the conductive bars and the end ring, in order to suppress deformation of the end ring caused by the centrifugal force, it is necessary to increase rigidity by reducing an inside diameter of the end ring or the like, whereby the rotary electric machine becomes heavier, which is a problem.

### Solution to Problem

According to a first aspect of the present invention, a squirrel cage rotor includes: a rotor core having a plurality of slots formed in a circumferential direction, each slot extending in an axial direction; a plurality of conductive bars housed within respective slots of the rotor core and having both end portions thereof projecting out from end faces of the rotor core in an axial direction; and a pair of end rings disposed at both ends of the rotor core, each end ring having a plurality of fitting portions into which the respective end portions of the conductive bar projecting out from the end faces of the rotor core in the axial direction are fitted. A material of the conductive bar is an aluminum alloy having an aluminum component ratio of 99.00% or more, and a material of the end ring is an aluminum alloy having proof stress higher than that of the material of the conductive bar.

According to a second aspect of the present invention, in the squirrel cage rotor according to the first aspect, it is preferable that the material of the end ring be an aluminum alloy having conductivity higher than that of duralumin and lower than that of an aluminum alloy having an aluminum component ratio of 99.00% or more.

According to a third aspect of the present invention, in the squirrel cage rotor according to the first or second aspect, it is preferable that the material of the end ring be an Al—Mg—Si alloy.

According to a fourth aspect of the present invention, in the squirrel cage rotor according to the first or second aspect, it is preferable that the material of the end ring be any of JIS A6063-T5, A6063-T6, A6101-T6, and A6151-T6.

According to a fifth aspect of the present invention, in the squirrel cage rotor according to the first or second aspect, it is preferable that the conductive bar be formed into an arc shape on a center axis side of the rotor in a cross-sectional shape in a plane orthogonal to the axial direction, a space be provided in the fitting portion, into which the conductive bar is fitted, on the center axis side of the rotor in the plane orthogonal to the axial direction, a curved portion is formed in the space on the center axis side of the rotor, and the curved portion of the space has a radius larger than a radius of the arc shape on the center axis side of the rotor of the conductive bar.

According to a sixth aspect of the present invention, a rotary electric machine includes: the squirrel cage rotor according to the first or second aspect; and a stator provided at an interval on an outer periphery side of the squirrel cage rotor.

### Advantageous Effects of Invention

According to the present invention, by using an aluminum alloy having proof stress higher than that of pure aluminum (i.e. an aluminum alloy having an aluminum component ratio of 99.00% or more) as a material of an end ring, it is possible to suppress an amount of deformation of the end ring when a squirrel cage rotor is rotated at a high speed. Accordingly, it is possible to provide a squirrel cage rotor, which can be light-weight and rotated at a high speed, and a rotary electric machine using the squirrel cage rotor.

### BRIEF DESCRIPTION OF DRAWINGS

FIG. 1 is a view illustrating a schematic configuration of a hybrid-type electric vehicle equipped with a rotary electric machine having a squirrel cage rotor according to an embodiment of the present invention.

FIG. 2 is a circuit diagram of a power converter in FIG. 1.

FIG. 3 is a partially sectioned schematic view of a rotary electric machine according to an embodiment of the present invention.

FIG. 4 is an external perspective view of a squirrel cage rotor according to an embodiment of the present invention.

FIG. 5 is an exploded perspective view of a squirrel cage rotor according to an embodiment of the present invention.

FIG. 6 is a partially enlarged schematic plan view illustrating an end ring of a squirrel cage rotor according to an embodiment of the present invention.

FIG. 7 is a table illustrating physical properties of each material used in a conductive bar and an end ring.

### DESCRIPTION OF EMBODIMENTS

Embodiments for carrying out the present invention are described herein with reference to the drawings.

### (Whole Rotary Electric Machine)

A rotary electric machine according to the present invention can be applied to a pure electric vehicle driven by a rotary electric machine only and to a hybrid-type electric vehicle driven by both an engine and a rotary electric machine. A hybrid vehicle is used as an example in descriptions herein.

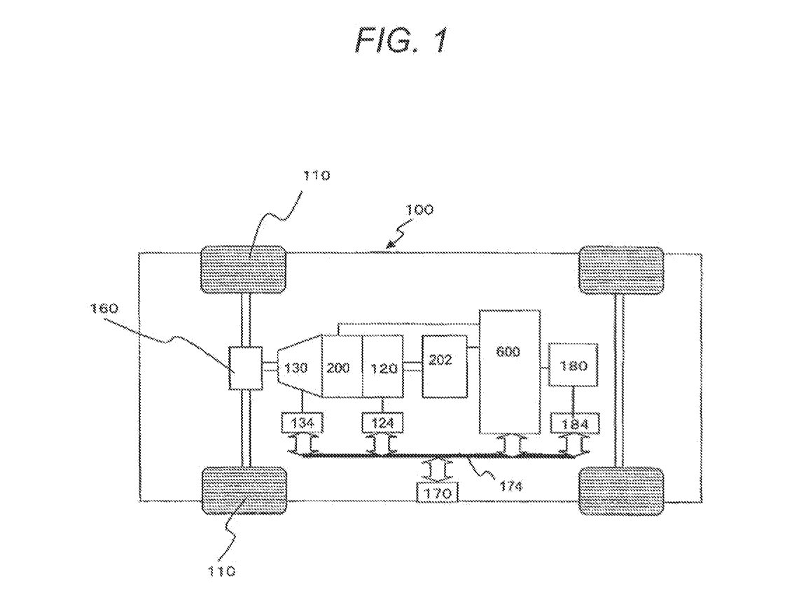

As illustrated in FIG. 1, a hybrid-type electric vehicle (hereinafter, vehicle) 100 includes an engine 120, a first rotary electric machine 200, a second rotary electric machine 202, and a high voltage battery 180.

The battery 180 is configured to be a secondary battery such as a lithium ion battery or a nickel-hydrogen battery, and it outputs a high voltage direct current (DC) power from 250 volt to 600 volt or above. The battery 180 supplies the DC power to the rotary electric machines 200 and 202 during power running. During regenerative running, the DC power is supplied from the rotary electric machines 200 and 202 to the battery 180. Giving and receiving of the DC power between the battery 180 and the rotary electric machines 200 and 202 is performed through a power converter 600.

The vehicle 100 is equipped with a battery (not illustrated) for supplying a low voltage electric power (for example, a 14 volt electric power). The battery supplies a DC power to a control circuit described below.

A rotational torque from the engine 120 and the rotary electric machines 200 and 202 is transmitted to a front wheel 110 through a transmission 130 and a differential gear 160. The transmission 130 is controlled by a transmission controller 134. The engine 120 is controlled by an engine controller 124. Charging and discharging of the battery 180 is controlled by a battery controller 184.

An integrated control device 170 is connected to the transmission controller 134, the engine controller 124, the battery controller 184, and the power converter 600 through a communication line 174.

The integrated control device 170 performs management of output torque from the engine 120 and the rotary electric machines 200 and 202, arithmetic processing of total torque of the output torque from the engine 120 and the output torque from the rotary electric machines 200 and 202 as well as a torque distribution ratio therebetween, and sending of a control command to the transmission controller 134, the engine controller 124, and the power converter 600 based on a result of the arithmetic processing.

Therefore, to the integrated control device 170, information indicating respective conditions of the transmission controller 134, the engine controller 124, the power converter 600, and the battery controller 184 is input therefrom through the communication line 174. These controllers are subordinate controllers of the integrated control device 170. Based on such information, the integrated control device 170 calculates a control command for each controller. The calculated control command is sent to each of the controllers through the communication line 174.

The battery controller 184 outputs a charging and discharging status of the battery 180 and a condition of each unit cell battery constituting the battery 180 to the integrated control device 170 through the communication line 174. The integrated control device 170 controls the power converter 600 based on information from the battery controller 184, and gives a command to generate power to the power converter 600 when it determines that charging of the battery 180 is necessary.

The power converter 600, based on a torque command from the integrated control device 170, controls the rotary electric machines 200 and 202 so as to generate a torque output or power generation according to the command. Therefore, the power converter 600 is provided with a power semiconductor constituting an inverter. The power converter 600 controls switching operation of the power semiconductor based on the command from the integrated control device 170. By the switching operation of the power semiconductor, the rotary electric machines 200 and 202 are operated as an electric motor or as a power generator.

In a case where the rotary electric machines 200 and 202 are operated as the electric motor, the DC power from the high voltage battery 180 is supplied to a DC terminal of the inverter of the power converter 600. The power converter 600, by controlling the switching operation of the power semiconductor, converts the supplied DC power into a three-phase alternating current (AC) power, and supplies it to the rotary electric machines 200 and 202.

In contrast, in a case where the rotary electric machines 200 and 202 are operated as the power generator, the rotor is rotary driven by the rotational torque applied from outside, whereby a three-phase AC power is generated in a stator winding. The generated three-phase AC power is converted into a DC power in the power converter 600, and by the DC power being supplied to the high voltage battery 180, charging is performed.

(Power Converter)

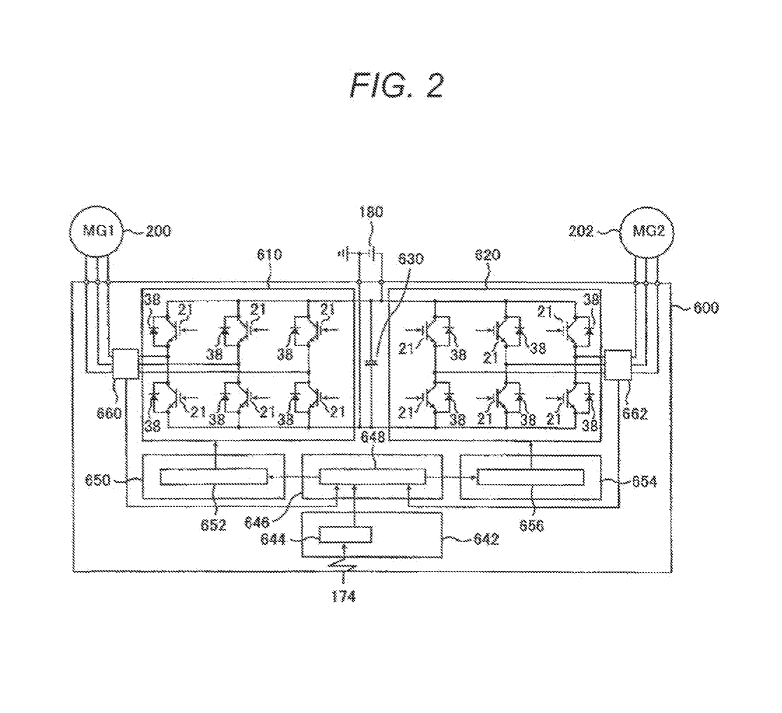

As illustrated in FIG. 2, the power converter 600 is provided with a first inverter device for the first rotary electric machine 200 and a second inverter device for the second rotary electric machine 202. The first inverter device is provided with a power module 610, a first driving circuit 652 for controlling switching operation of each of power semiconductor elements 21 of the power module 610, and a current sensor 660 for detecting current of the rotary electric machine 200. The driving circuit 652 is provided on a driving circuit substrate 650.

A second inverter device is provided with a power module 620, a second driving circuit 656 for controlling switching operation of each of power semiconductor elements 21 of the power module 620, and a current sensor 662 for detecting current of the rotary electric machine 202. The driving circuit 656 is provided on a driving circuit substrate 654.

The current sensors 660 and 662 and the driving circuits 652 and 656 are connected to a control circuit 648 provided on a control circuit substrate 646. Furthermore, the communication line 174 is connected to the control circuit 648 through a transmission/reception circuit 644. The transmission/reception circuit 644 is provided on a transmission/reception circuit substrate 642, and is commonly used by the first and second inverter devices. The transmission/reception circuit 644 is used for electrically connecting the power converter 600 to an external controller, and performs transmission/reception of information with another device through the communication line 174 in FIG. 1.

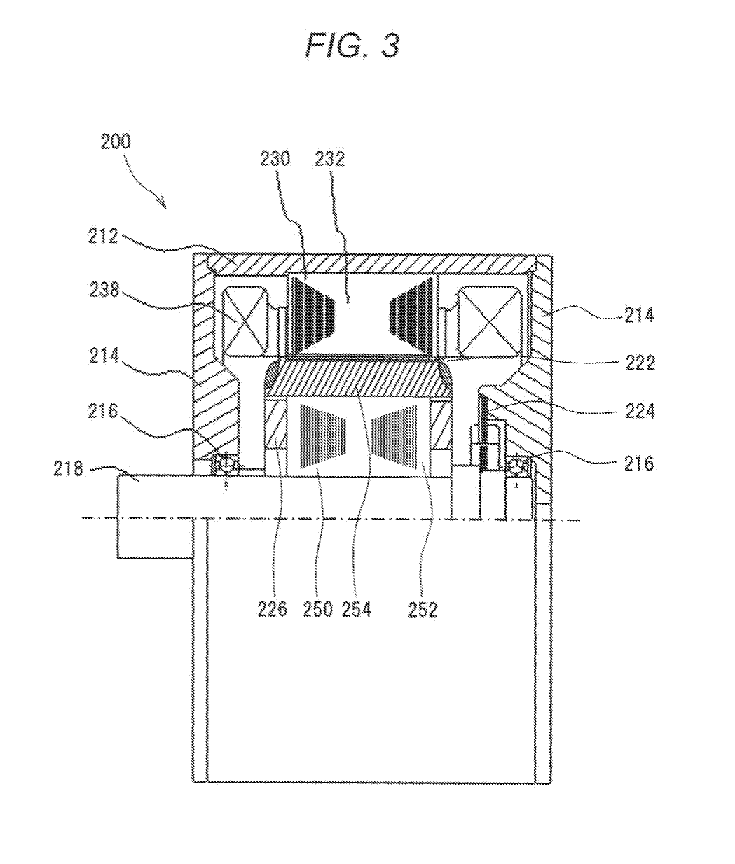

The control circuit 648 constitutes a control unit of each inverter devices, and includes a microcomputer for calculating a control signal (control value) for (on/off) operating the power semiconductor elements 21. The control circuit 648 is input with a torque command signal (torque command value) from the integrated control device 170, a sensor output from the current sensors 660 and 662, and a sensor output from a rotation sensor, or a resolver 224 (see FIG. 3), mounted on the rotary electric machines 200 and 202. Based on these input signals, the control circuit 648 calculates the control value and outputs the control signal for controlling switching timing to the driving circuits 652 and 656.

Each of the driving circuits 652 and 656 is provided with six integrated circuits for generating a driving signal supplied to a gate of each of upper and lower arms of each phase, and six integrated circuits constitute one block. The driving signal generated in the driving circuits 652 and 656 is output to a gate of each of the power semiconductor elements 21 of the corresponding power modules 610 and 620.

To a DC side terminal of the power modules 610 and 620, a capacitor module 630 is electrically connected in parallel. The capacitor module 630 constitutes a smoothing circuit for suppressing fluctuation in a DC voltage caused by the switching operation of the power semiconductor elements 21. The capacitor module 630 is commonly used by the first and second inverter devices.

Each of the power modules 610 and 620 converts the DC power supplied from the battery 180 into a three-phase AC power, and supplies it to a stator winding, which is an armature winding of the corresponding rotary electric machines 200 and 202. The power modules 610 and 620 convert an AC power induced by the stator winding of the rotary electric machines 200 and 202 into DC, and supply it to the high voltage battery 180.

As in FIG. 2, each of the power modules 610 and 620 has a three-phase bridge circuit, and a series circuit corresponding to each of the three phases is electrically connected in parallel to the battery 180 between a positive electrode side thereof and a negative electrode side thereof. Each series circuit is provided with a power semiconductor element 21 constituting an upper arm and a power semiconductor element 21 constituting a lower arm, and these power semiconductor elements 21 are connected in series.

The power module 610 and the power module 620 are configured to be substantially the same, whereby the power module 610 is representatively used in the descriptions herein.

The power module 610 uses an insulated gate bipolar transistor (IGBT) as a power semiconductor element for switching. The IGBT is provided with three electrodes, which are a collector electrode, an emitter electrode, and a gate electrode. A diode 38 is electrically connected between the collector electrode and the emitter electrode of the IGBT. The diode 38 is provided with two electrodes, which are a cathode electrode and an anode electrode. The cathode electrode is electrically connected to the collector electrode of the IGBT, and the anode electrode is electrically connected to the emitter electrode of the IGBT, respectively, such that a direction from the emitter electrode to the collector electrode of the IGBT becomes a forward direction.

An arm of each phase is configured such that the emitter electrode of the IGBT is electricity connected to the collector electrode of the IGBT in series.

Note that in FIG. 2, only one IGBT is illustrated for each of the upper and lower arms of each phase, but in actuality a plurality of IGBTs are electricity connected in parallel in the configuration since a current capacity to be controlled is large.

The collector electrode of the IGBT of each of the upper arms of each phase is electrically connected to a positive electrode side of the battery 180, and the emitter electrode of the IGBT of each of the lower arms of each phase is electrically connected to a negative electrode side of the battery 180. A midpoint of each of the arms of each phase (a connecting part between the emitter electrode of the IGBT on the upper arm side and the collector electrode of the IGBT on the lower arm side) is electrically connected to an armature winding (stator winding) of a corresponding phase of the corresponding rotary electric machines 200 and 202.

The rotary electric machines 200 and 202 are configured to be substantially the same, whereby the rotary electric machine 200 is representatively used in the descriptions herein.

(Configuration of Rotary Electric Machine)

As illustrated in FIG. 3, the rotary electric machine 200 includes a housing 212, and a stator 230 held inside the housing 212. The stator 230 is provided with a stator core 232 and a stator winding 238. Inside the stator core 232, a rotor 250 is rotatably held through a gap 222. In other words, the stator core 232 is disposed on an outer periphery side of the rotor 250 with the gap 222. The rotor 250 includes a rotor core 252, a conductive bar 254, and an end ring 226. The rotor core 252 is fixed to a cylindrical shaft (axis of rotation body) 218.

The housing 212 includes a pair of end brackets 214, each of which is provided with a bearing 216. The shaft 218 is rotatably held by the bearing 216. The shaft 218 is provided with the resolver 224 for detecting a rotation position and a rotating speed of the rotor 250. Output from the resolver 224 is input to the control circuit 648 illustrated in FIG. 2.

Describing with reference to FIG. 2, the control circuit 648 controls the driving circuit 652 based on the output from the resolver 224. The driving circuit 652 converts the DC power supplied from the battery 180 into a three-phase AC power by performing switching operation of the power module 610. In the same way, the control circuit 648 performs switching operation of the power module 620 through the driving circuit 656, and converts the DC power supplied from the battery 180 into the three-phase AC power. This three-phase AC power is supplied to the stator winding 238, and a rotating magnetic field is generated in the stator 230. A frequency of the three-phase AC is controlled based on a detection value of the resolver 224, and a phase of the three-phase AC relative to the rotor 250 is also controlled based on the detection value of the resolver 224, whereby the three-phase AC power is supplied to the stator winding 238.

(Stator)

As illustrated in FIG. 3, the stator 230 is provided with the cylindrical stator core 232 and the stator winding 238 inserted into the stator core 232. The stator core 232 is formed by layering a plurality of annular shaped magnetic steel sheets. The magnetic steel sheets constituting the stator core 232 are about 0.05 to 1.0 mm in thickness, and are formed by punching work or etching work.

The stator core 232 is formed by layering the magnetic steel sheets such that a plurality of slots (not illustrated) extending in an axial direction of the stator core 232 is at equal intervals in a circumferential direction. The slots are provided with insulating paper (not illustrated) corresponding to a slot shape, and phase windings of U, V, and W phases constituting the stator winding 238 are housed therein. A tooth formed between slots leads the rotating magnetic field generated by the stator winding 238 to the rotor 250, and generates rotational torque in the rotor 250.

In this embodiment, a distributed winding is used as a winding method of the stator winding 238. The distributed winding is a winding method in which a phase winding is wound around the stator core 232 such that a phase winding of each phase is housed in two separated slots passing over a plurality of slots.

(Rotor)

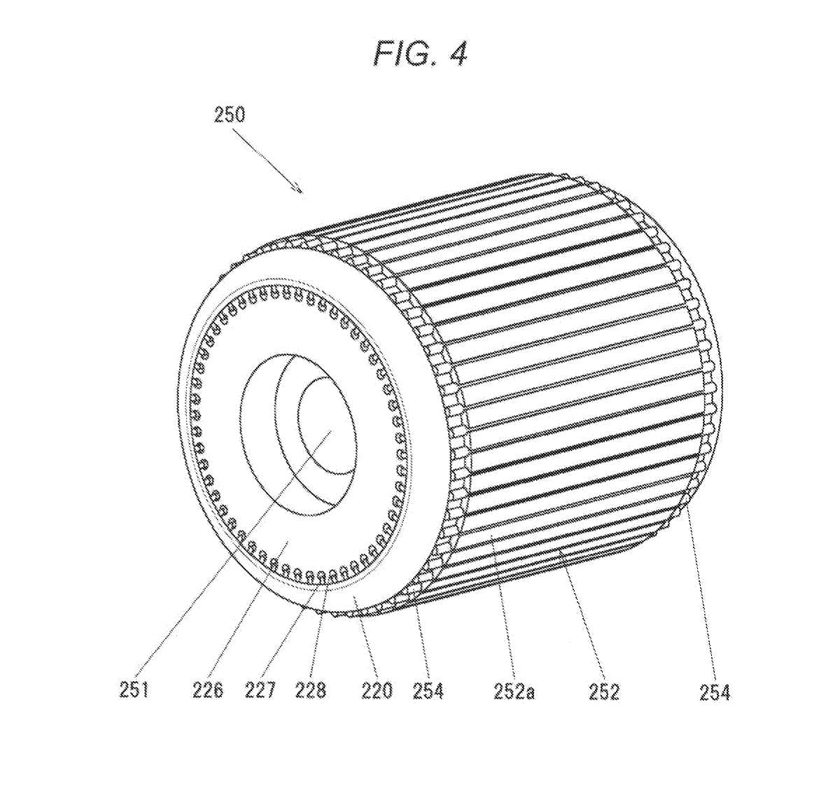

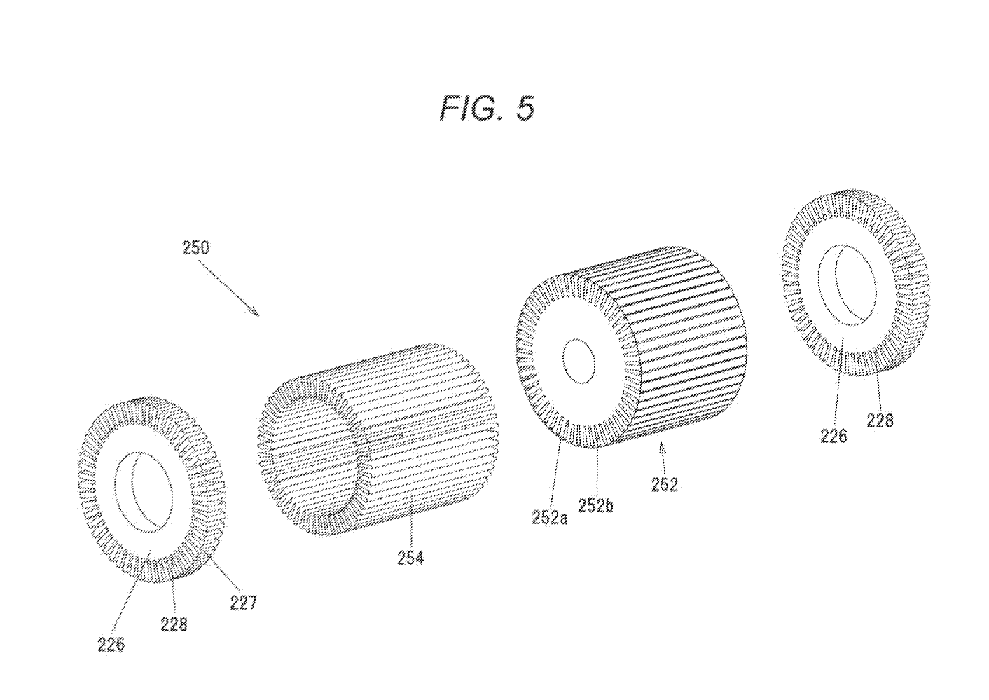

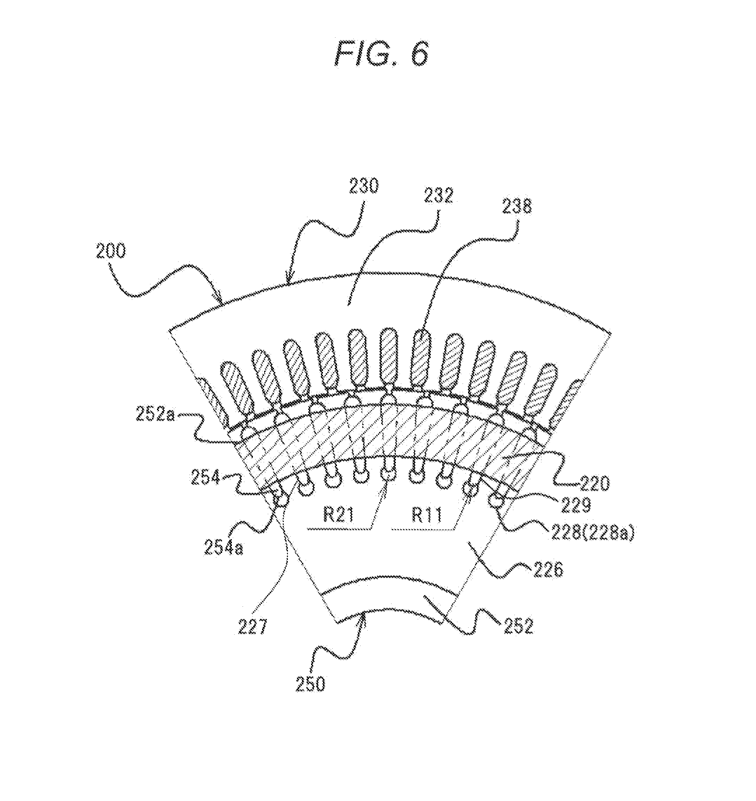

FIGS. 4 and 5 are an external perspective view and an exploded perspective view of the rotor 250 according to this embodiment. FIG. 6 is a partially enlarged schematic plan view illustrating the end ring 226 of the rotor 250 according to this embodiment. Note that the shaft 218 is omitted in these figures. As illustrated in FIGS. 4 and 5, the rotor 250 according to this embodiment is an assembly type squirrel cage rotor in which many conductive bars 254 and a pair of end rings 226 are assembled to the rotor core 252. At both ends in an axial direction of the rotor 250, the end rings 226 and the conductive bars 254 are connected by welding.

In this embodiment, as illustrated in FIG. 6, by forming an arc-shaped cavity portion 228, which is slightly larger than a tip part of the conductive bar 254 (center side end portion 254a), in a fitting portion 227 of the end ring 226 in advance, it is possible to decrease a stress concentration applied to the end ring 226 caused by a rotational centrifugal force generated when the rotor 250 is rotated at a high speed (for example, a circumferential speed of 250 m/s. The circumferential speed is an amount defined by (outside diameter/2)×angular velocity.). A configuration of the rotor 250 and configurations of the conductive bar 254 and the end ring 226 are described herein in detail.

As illustrated in FIGS. 4 and 5, the rotor 250 is cylindrically shaped and has a through hole 251 through which the shaft 218 (see FIG. 3) is inserted. The rotor 250 is provided with the cylindrically shaped rotor core 252, a plurality of conductive bars 254 inserted into a slot 252b of the rotor core 252, and a pair of end rings 226 disposed at both ends of the rotor core 252 and electricity connected with the conductive bars 254 by welding.

(Rotor Core)

The rotor core 252 is formed by layering a plurality of annular shaped magnetic steel sheets. The magnetic steel sheets constituting the rotor core 252 are about 0.05 to 1.0 mm in thickness, and are formed by punching work or etching work. In the rotor core 252, a plurality of teeth 252a and the plurality of slots 252b, which are parallel to an axial direction, are respectively formed at equal intervals in a circumferential direction.

A width of the tooth 252a (a length in a circumferential direction) of the rotor core 252 is substantially constant from the rotation center side (base portion) to outside in a radial direction. A width of the slot 252b partitioned by the adjacent teeth 252a is the largest on an outer periphery side (opening side). The width becomes smaller from the outer periphery side to inside in the radial direction, and is the smallest on the rotation center side.

Inside each of the slots 252b extending in a direction of rotation center axis, a long flat plate shaped conductive bar 254 is housed. Both of the end portions in a longitudinal direction of the conductive bar 254 are fitted into a pair of end rings 226 disposed at both ends of the rotor core 252.

(Conductive Bar and End Ring)

The conductive bar 254 is a long flat plate shaped member extending in the axial direction of the rotor 250. The conductive bar 254 has an external shape substantially the same as the slot 252b of the rotor core 252, and is housed inside the slot 252b. The conductive bar 254 has a cross-sectional shape, in a plane orthogonal to the direction of rotation center axis of the rotor 250, in which it is tapered such that the thickness gradually decreases from an outer periphery side to a center side of the rotor 250, and it is formed into an arc shape on a rotation center axis side of the rotor.

As illustrated in FIG. 6, in the conductive bar 254, a flat side surface is formed such that the thickness is decreased gradually from the outer periphery side to the center side of the rotor 250, an arc-shaped center side end portion 254a is formed so as to extend from both side surfaces toward a center axis side of the rotor 250, and an arc-shaped outside end portion is formed so as to extend from both side surfaces toward outside in a radial direction of the rotor 250.

As illustrated in FIG. 4, the conductive bar 254 is formed to be longer than a length of the rotor core 252 in an axial direction, whereby both end portions of the conductive bar 254 project out from end faces in the axial direction of the rotor core 252.

A pair of end rings 226 is disposed at both ends of the rotor core 252. Each of the end rings 226 has the plurality of fitting portions 227 into which the end portions of the conductive bar 254 projecting out from the end faces of the rotor core 252 in the axial direction is fitted. The plurality of fitting portions 227 is formed so as to be at equal intervals in a circumferential direction relative to the slots 252b of the rotor core 252. Each of the fitting portions 227 is a through hole parallel to the axial direction, and is formed into a groove shape opened on an outer periphery side.

Into each of the fitting portions 227 of each of the end rings 226, the end portion in a longitudinal direction of the conductive bar 254 is fitted. The conductive bar 254 is connected to the end ring 226 by welding, whereby an annular connecting part 220 is formed.

(Fitting Portion)

A shape of the fitting portion 227 of the end ring 226 is described in detail with reference to FIG. 6. The fitting portion 227 has a cross-sectional shape substantially the same as the conductive bar 254, and includes a holding portion 229 for holding the conductive bar 254, and a cavity portion 228 running from the holding portion 229 toward a center axis side of the rotor 250.

The cavity portion 228 is formed as an arc-shaped portion 228a having a radius larger than that of an arc constituting the center side end portion 254a of the conductive bar 254. As illustrated in FIG. 6, a relationship between a radius R21 of the cavity portion 228 (arc-shaped portion 228a) provided at an end on the center axis side of the rotor 250 in the fitting portion 227, and a radius R11 of the center side end portion 254a of the conductive bar 254 is R21>R11, and in this embodiment, R21≈1.8×R11.

As illustrated in FIG. 6, the conductive bar 254 is fitted into the fitting portion 227 of the end ring 226 such that the cavity portion 228 (arc-shaped portion 228a) faces the center side end portion 254a of the conductive bar 254. In a plane orthogonal to a direction of center axis of the rotor 250, a gap is formed between the center side end portion 254a of the conductive bar 254 and the cavity portion 228 (arc-shaped portion 228a).

(Material of Conductive Bar and End Ring)

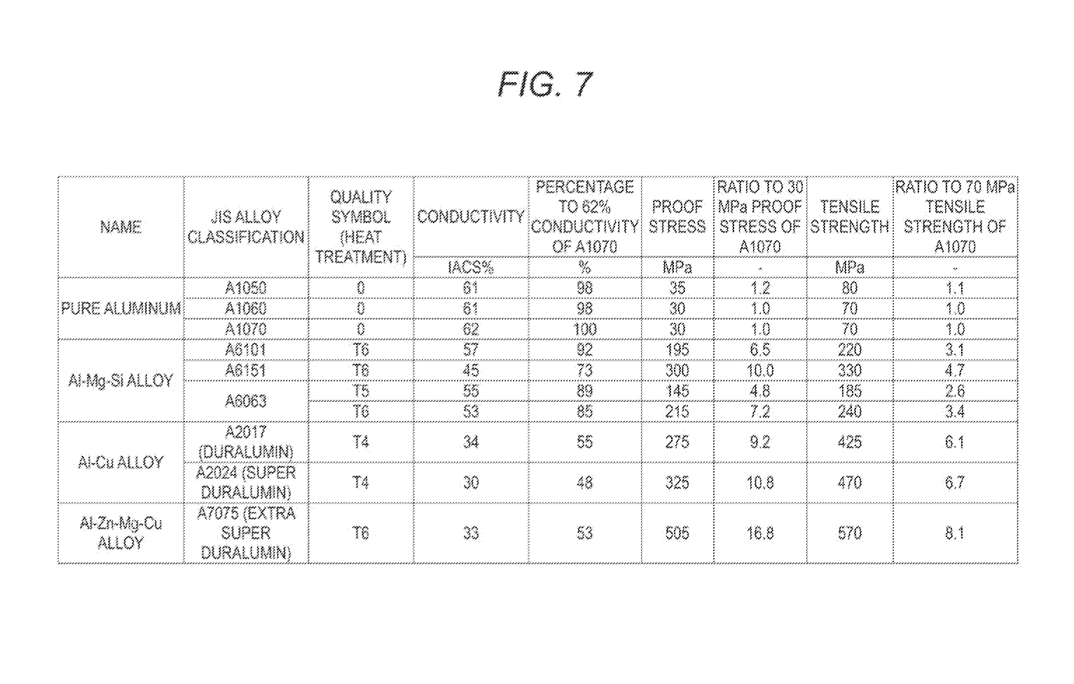

FIG. 7 is a table illustrating physical properties of each material used in the conductive bar 254 and the end ring 226. In this embodiment, pure aluminum is used as a material of the conductive bar 254, and an Al—Mg—Si alloy is used as a material of the end ring 226. The pure aluminum means an aluminum alloy having an aluminum component ratio of 99.00% or more.

As illustrated in FIG. 7, JIS A1050, A1060, and A1070, which are pure aluminum, have high conductivity compared to other materials illustrated in FIG. 7. Therefore, by using any of JIS A1050, A1060, and A1070, which are pure aluminum, as the material of the conductive bar 254, it is possible to improve motor efficiency (ratio of output mechanical energy to input electrical energy) of the rotary electric machine 200.

As illustrated in FIG. 7, JIS A2017 (duralumin)-T4 and A2024 (super duralumin)-T4, which are Al—Cu alloys, and JIS A7075 (extra super duralumin)-T6, which is an Al—Zn—Mg—Cu alloy, all have tensile strength higher than that of another material illustrated in FIG. 7, and also have proof stress higher than that of the other materials excluding JIS A6151-T6.

Nevertheless, JIS A2017-T4, A2024-T4, and A7075-T6 have conductivity lower than that of the other materials illustrated in FIG. 7. For example, the conductivity thereof is from 48% to 55% of the conductivity of JIS A1070, which is pure aluminum. Accordingly, in a case where JIS A2017-T4, A2024-T4, or A7075-T6 is used as the material of the conductive bar 254 or of the end ring 226, there is a concern of a decreased motor efficiency.

As illustrated in FIG. 7, JIS A6101-T6, A6151-T6, A6063-T5, and A6063-T6, which are Al—Mg—Si alloys, have the conductivity slightly smaller than that of JIS A1050, A1060, and A1070, which are pure aluminum, but have the proof stress higher than that of JIS A1050, A1060, and A1070, which are pure aluminum.

For example, JIS A1070 having the highest conductivity among the pure aluminum illustrated in FIG. 7, and JIS A6101-T6 having the highest conductivity among the Al—Mg—Si alloys illustrated in FIG. 7 are compared. Compared to the conductivity of JIS A1070, the conductivity of JIS A6101-T6 is 92%, whereby the difference therebetween is very small. In contrast, compared to the proof stress of JIS A1070, the proof stress of JIS A6101-T6 is 6.5 times, whereby the difference therebetween is very large.

JIS A1070 having the highest conductivity among the pure aluminum illustrated in FIG. 7 and JIS A6063-T6 illustrated in FIG. 7 are compared. Compared to the conductivity of JIS A1070, the conductivity of JIS A6063-T6 is 85%, whereby the difference therebetween is small. In contrast, compared to the proof stress of JIS A1070, the proof stress of JIS A6063-T6 is 7.2 times, whereby the difference therebetween is very large.

JIS A1070 having the highest conductivity among the pure aluminum illustrated in FIG. 7 and JIS A6151-T6 having the lowest conductivity among the Al—Mg—Si alloys illustrated in FIG. 7 are compared. Compared to the conductivity of JIS A1070, the conductivity of JIS A6151-T6 is 73%, whereby the difference there between is small at 27%. In contrast, compared to the proof stress of JIS A1070, the proof stress of JIS A6151-T6 is 10.0 times, whereby the difference therebetween is very large.

Accordingly, by using any of JIS A6101-T6, A6151-T6, A6063-T5, and A6063-T6 as the material of the end ring 226, it is possible to suppress an amount of deformation of the end ring 226 caused by the centrifugal force when the rotor 250 is rotated at a high speed while suppressing a decrease in the motor efficiency.

According to the above described embodiment, the following actions and effects can be enjoyed.

(1) Any of JIS A1050, A1060, and A1070, which are pure aluminum, is used as the material of the conductive bar 254, and any of JIS A6101-T6, A6151-T6, A6063-T5, and A6063-T6, which are Al—Mg—Si alloys, is used as the material of the end ring 226. Compared to the pure aluminum, the Al—Mg—Si alloy has high proof stress, whereby it is possible to suppress the amount of deformation of the end ring 226 caused by the centrifugal force when the rotor 250 is rotated at a high speed.

Conventionally, in a case where the end ring 226 is formed of pure aluminum, rigidity is ensured by reducing an inside diameter of the end ring 226 and the like in order to suppress the amount of deformation during a high-speed rotation, whereby there is a problem in that the rotary electric machine becomes heavy. In contrast, according to this embodiment, it is possible to suppress the amount of deformation without reducing the inside diameter of the end ring 226 during the high-speed rotation, whereby it is possible to save weight of the rotor 250 and the rotary electric machine 200.

Note that in a case where the rotary electric machine 200 is mounted in an engine room of a hybrid-type electric vehicle and the like, a mounting space may not be sufficient due to a space saving demand, whereby a gap between the rotor 250 and surrounding members may be narrow. According to this embodiment, even in a case where the rotor 250 is rotated at a high speed under such an environment, it is possible to suppress the amount of deformation of the end ring 226, whereby the end ring 226 and the surrounding members will not come in contact.

(2) Compared to the conductivity of the pure aluminum (for example, A1070), a difference in the conductivity of the Al—Mg—Si alloys illustrated in FIG. 7 is small between 8% and 27%, whereby it is possible to suppress a decrease in the motor efficiency as small as possible.

(3) According to this embodiment, by (1) and (2), it is possible to provide the squirrel cage rotor 250 in which a decrease in the motor efficiency is suppressed and weight-saving and high rotation is achieved, and the rotary electric machine 200 using the squirrel cage rotor 250.

(4) The fitting portion 227 of the end ring 226 is provided with the cavity portion 228 (arc-shaped portion 228a) having a radius larger than that of the center side end portion 254a of the conductive bar 254. By the rotor 250 rotating at a high speed, a centrifugal force is applied to the end ring 226, whereby tensile stress is generated in a circumferential direction. By forming the cavity portion 228 into an arc shape having a radius larger than that of the center side end portion 254a of the conductive bar 254, the stress concentration applied to the cavity portion 228 (arc-shaped portion 228a) of the end ring 226 is decreased. Accordingly, it is possible to prevent damage on the end ring 226 caused by the rotational centrifugal force generated by rotating the rotor 250 at a high speed.

Note that modifications as below are also included within the scope of the present invention, and it is possible to combine one or more of the modifications with the above-described embodiment.

(1) In the above-described embodiment, a case in which the material of the conductive bar 254 is any of JIS A1050, A1060, and A1070 has been described; however, the present invention is not to be limit to this. The material of the conductive bar 254 may also be pure aluminum different from JIS A1050, A1060, or A1070, such as JIS A1100.

(2) In the above-described embodiment, a case in which the material of the end ring 226 is any of JIS A6063-T5, A6063-T6, A6101-T6, and A6151-T6 has been described; however, the present invention is not to be limited to this. The material of the end ring 226 may also be an Al—Mg—Si alloy different from JIS A6063-T5, A6063-T6, A6101-T6, or A6151-T6, such as JIS A6061-T6.

(3) A connecting method of the conductive bar 254 and the end ring 226 is not to be limited to welding. The conductive bar 254 and the end ring 226 may also be connected by connecting methods such as the friction-stirring welding (FSW), brazing, and ultrasonic soldering.

(4) As a power semiconductor element for switching, a metal-oxide-semiconductor field-effect transistor (MOSFET) may be used in place of IGBT. The MOSFET has three electrodes, which are a drain electrode, a source electrode, and a gate electrode. In a case where the MOSFET is used, between the source electrode and the drain electrode, there is provided a parasitic diode in which a direction from the drain electrode to the source electrode is a forward direction, whereby it is not necessary to provide the diode 38 in FIG. 2.

(5) In the above-described embodiment, a plurality of magnetic steel sheets is layered to form the rotor core 252 and the stator core 232; however, the present invention is not to be limited to this.

(6) The rotary electric machines 200 and 202 can also be applied to other electric vehicles, for example, railway vehicles such as a hybrid train, passenger vehicles such as a bus, cargo vehicles such as a truck, industrial vehicles such as a battery type forklift truck, and the like.

(7) In the above-described embodiments, the entire cavity portion 228 is formed as the arc-shaped portion 228a; however, the present invention is not to be limited to this. It is also possible to form only an end on the center axis side of the rotor in the cavity portion 228 into an arc-shaped portion having a radius larger than the radius R11 of the center side end portion 254a of the conductive bar 254. That is, it is also possible to form the end on the center axis side of the rotor in the cavity portion 228 into a curved portion including the arc-shaped portion, having a radius larger than the radius R11 of the center side end portion 254a of the conductive bar 254, and the curved portion and the holding portion 229 may be continuously connected through a linear portion and a bent portion.

Various embodiments and modifications have been described as above; however, the present invention is not to be limit to these descriptions. Other aspects considerable within a scope of technical ideas of the present invention may also be included within the scope of the present invention.

The disclosure of the following priority application is herein incorporated by reference:

Japanese Patent Application No. 2011-187098 (filed on Aug. 30, 2011).

1. A squirrel cage rotor comprising:
a rotor core having a plurality of slots formed in a circumferential direction, each slot extending in an axial direction;
a plurality of conductive bars housed within the respective slots of the rotor core and having both end portions thereof projecting out from end faces in an axial direction of the rotor core; and
a pair of end rings disposed at both ends of the rotor core, each end ring having a plurality of fitting portions into which the respective end portions of the conductive bar projecting out from the end faces in the axial direction of the rotor core are fitted,
wherein a material of the conductive bar is an aluminum alloy having an aluminum component ratio of 99.00% or more, and
a material of the end ring is an aluminum alloy having proof stress higher than that of the material of the conductive bar, the conductive bar is formed into an arc shape on a center axis side of the rotor in a cross-sectional shape in a plane orthogonal to the axial direction,
a space is provided in the fitting portion, into which the conductive bar is fitted, on the center axis side of the rotor in the plane orthogonal to the axial direction, and a curved portion is formed in the space on the center axis side of the rotor, and
the curved portion of the space has a radius larger than a radius of the arc shape on the center axis side of the rotor of the conductive bar.

2. The squirrel cage rotor according to claim 1, wherein
the material of the end ring is an aluminum alloy having conductivity higher than that of duralumin and lower than that of an aluminum alloy having an aluminum component ratio of 99.00% or more.

3. The squirrel cage rotor according to claim 1, wherein
the material of the end ring is an Al—Mg—Si alloy.

4. The squirrel cage rotor according to claim 1, wherein
the material of the end ring is any of JIS A6063-T5, A6063-T6, A6101-T6, and A6151-T6.

5. (canceled)

6. A rotary electric machine comprising:
the squirrel cage rotor according to claim 1; and
a stator provided at an interval on an outer periphery side of the squirrel cage rotor.
